(19) United States
(12) Patent Application Publication
(10) Pub. No.: US 2014/0180624 A1
(43) Pub. Date: Jun. 26, 2014

(54) SENSING AND RESPONSIVE FABRIC

(71) Applicants: Dmitri E. Nikonov, Portland, OR (US); Vivek K. Singh, Portland, OR (US); Shawna M. Liff, Gilbert, AZ (US)

(72) Inventors: Dmitri E. Nikonov, Portland, OR (US); Vivek K. Singh, Portland, OR (US); Shawna M. Liff, Gilbert, AZ (US)

(21) Appl. No.: 13/725,176

(22) Filed: Dec. 21, 2012

(51) Int. Cl. G01K 1/14; G01K 7/00

(52) U.S. Cl. CPC G01K 1/14; G01K 7/00
USPC 702/130; 29/854; 29/601

(57) ABSTRACT

A sensing and responsive fabric is described. In one example the fabric has a sensor formed of a fiber of the fabric, a transducer formed of a fiber of the fabric, and a processor coupled to the sensor to measure a sensor characteristic and to the transducer to apply power to the transducer based on the sensor measurement.

### FIELD

The present disclosure relates to the field of fabric and garments and, in particular, to a fabric that senses conditions and responds to those conditions.

### BACKGROUND

While computing performance continues to increase and environmental control systems become more sophisticated and automated, fabrics continue to rely on passive physical characteristics of the underlying materials. This may be sufficient as long as environmental conditions are static. However, if the surrounding environment changes, then a fabric may become inappropriate for a particular application. As a result, clothing that is appropriate for cold weather must be changed before going into mild or hot weather and vice versa. Similarly, an insulating wrap may prevent heat loss during in the cold but cause overheating in higher temperatures. Changing fabrics in any such circumstance may involve inconvenience, cost, or delay, depending on how the fabric is used.

On the other hand, computing and information processing devices progress in the direction of becoming ubiquitous in human environment. Wearable computing systems as well as devices embedded in appliances are increasingly common and connected to the internet.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a diagram of a fabric having sensing and responsive elements and sewn together to form a shirt according to an embodiment of the invention.

FIG. 2 is a diagram of a fabric showing a weave with structural, sensor, and transducer fibers according to an embodiment of the invention.

FIG. 3 is a diagram of a temperature sensing thread according to an embodiment of the invention.

FIG. 4 is a diagram of heat transducing thread according to an embodiment of the invention.

FIG. 5 is a diagram of a stress sensing thread according to an embodiment of the invention.

FIG. 6 is a diagram of a constrictive transducing thread according to an embodiment of the invention.

FIG. 7 is a process flow diagram of sensing and transducing in a fabric according to an embodiment of the invention.

FIG. 8 is a process flow diagram of sensing and transducing in a fabric according to another embodiment of the invention.

FIG. 9 is a process flow diagram of sensing and transducing in a fabric according to a third embodiment of the invention.

FIG. 10 is a block diagram of a computing device according to an embodiment of the invention.

### DETAILED DESCRIPTION

The present disclosure relates to electronic devices based on wearable and embedded fabrics. As described herein, a fabric or textile may be created with a capability of sensing the environment and adjusting its properties depending on what is sensed. This functionality can be based on a program loaded to the fabric device or based on instructions from a human or a controlling information system. Such a fabric can find applications in clothing, upholstery, structural elements, and filters, among others. The fabric can be made as a system including a multitude of various sensor and transducer threads. The system may be controlled by a CPU (Central Processing Unit) connected with electronic threads and may also contain a battery to provide power for its operation. The CPU can be wirelessly connected to a main computing system, for example, a “smart home” system, or a manufacturing control system.

The fabric may be made to seem almost sentient in that it is like a unified system sensing multiple physical quantities and adjusting its responses based on the sensing. The embedded processor runs a program to interpret the sensed physical quantities and determine responses. The processor may use self-learning AI (Artificial Intelligence) to control the fabric. The fabric can act without human interference or human user interface.

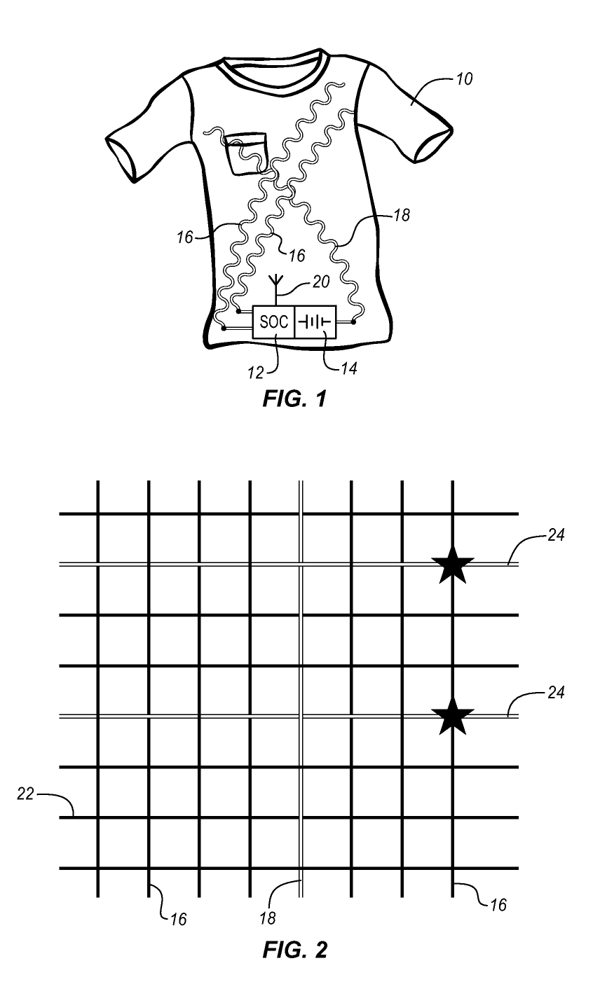

FIG. 1 is a diagram of a garment 10 such as a shirt that has been woven or sewn together using a specialized fabric. While a shirt is shown, similar principles may be applied to other garments, such as pants, shoes, stockings, skirts, blouses, caps, and hats as well as to other types of fabric implements such as drapery, curtains, pipe wrapping, insulators, etc. The shirts 10 has a processing system 12 such as a system on a chip (SOC) that may include processing resources, memory program instructions, and input/output (I/O) interfaces. The SOC is powered by a battery 14 coupled to the SOC. The fabric of the shirt has structural threads (not shown), sensor threads 16, and transducer threads 18.

The structural threads provide structure to the fabric and hold and carry the sensor and transducer threads. The structural threads also hold the sensor and transducer threads in specific positions within the fabric. They may maintain a particular distance or location of the sensor and transducer threads, depending on the particular implementation.

The sensor threads are coupled to the processor of the system on a chip and provide sensor input into the processor. The transducer threads 18 are activated by the processor and are shown in this example as being coupled to the battery 14 so that the transducer threads may be powered. However, the transducer threads may be coupled to the processor or a specialized interface to allow the transducer threads to be powered and controlled. The garment also includes an antenna 20 which may be used to allow the SOC to communicate with external devices for variety of different purposes.

In one embodiment, the wireless connection is used to transmit the instructions for fabric responses from a human, a manufacturing control system, or a “smart home”. In another embodiment, the wireless connection transmits the state of the fabric to a wider sensor network. Furthermore, power for the operation of the system can be delivered wirelessly from an external source

The sensor threads and transducer threads may be woven into the garment with structural threads or applied to the garment external to the structure of the fabric from which the garment is made. The SOC and the battery may be carried in a small pocket or integrated into the garment in any of a variety of different ways.

Alternatively, the battery may be constructed of galvanic threads or fibers that are woven into or attached to the garment. The galvanic threads may be connected to the processor to power the processor and may also or alternatively be connected to either the sensor or transducer fibers to supply power to the sensor or transducer. The galvanic fibers may generate current based on the surrounding environment or based on other materials in the fabric.

FIG. 2 is in an exploded diagram of a fabric suitable for the garment 10 of FIG. 1. The garment is woven with a warp and weft or woof of structural fibers 22 these fibers may be formed of cotton, nylon, polyester, or any of a variety of other typical fabric fibers including blends thereof. Interwoven with the structural fibers are sensing fibers 16 and actuating or transducing fibers 18. In the example of FIG. 2, these fibers are woven into the end of the fabric together with the structural fibers to form a single fabric that includes sensing and actuating characteristics. In one example, there may be electrical connection fibers 24 in the warp of the fiber that cross and contact sensing fibers 16 in the weft of the fabric. The electrical contacts between the electrical connection fibers 24 and the sensing fibers 16 or transducer fibers 18 may be connected using an electric discharge (shown as stars) at points 26 to fuse the crossing of the fibers during the weaving of the fabric. This may be repeated on every weft of the fiber. Galvanic fibers (not shown) may also be woven into the fabric.

By applying such an approach to both the sensors and the actuators, the entire fabric may be covered with a single sensor and a single actuator. In a similar way, multiple sensors can be combined by carefully applying electric discharges that fuse the crossings of only certain fibers. In the example of a temperature sensor, the result of a fused set of temperature sensing fibers across the whole fabric results in a single temperature sensor that averages the sensed temperature through the entire fabric. The temperature is averaged because all of the sending thread are coupled together to generate a single combined response to the temperature. In the same way by electrically connecting all of the actuating fibers, a single control applied to the actuating fiber can cause all of the actuating fibers to behave in a similar way.

In contrast to traditionally woven fabrics, similar approaches may be used with electro-spun fabrics. The sensing and actuating fibers may be incorporated into the electro-spinning process or either the sensing or actuating fibers or both may be applied to an electro-spun or other non-woven fabric, such as felts.

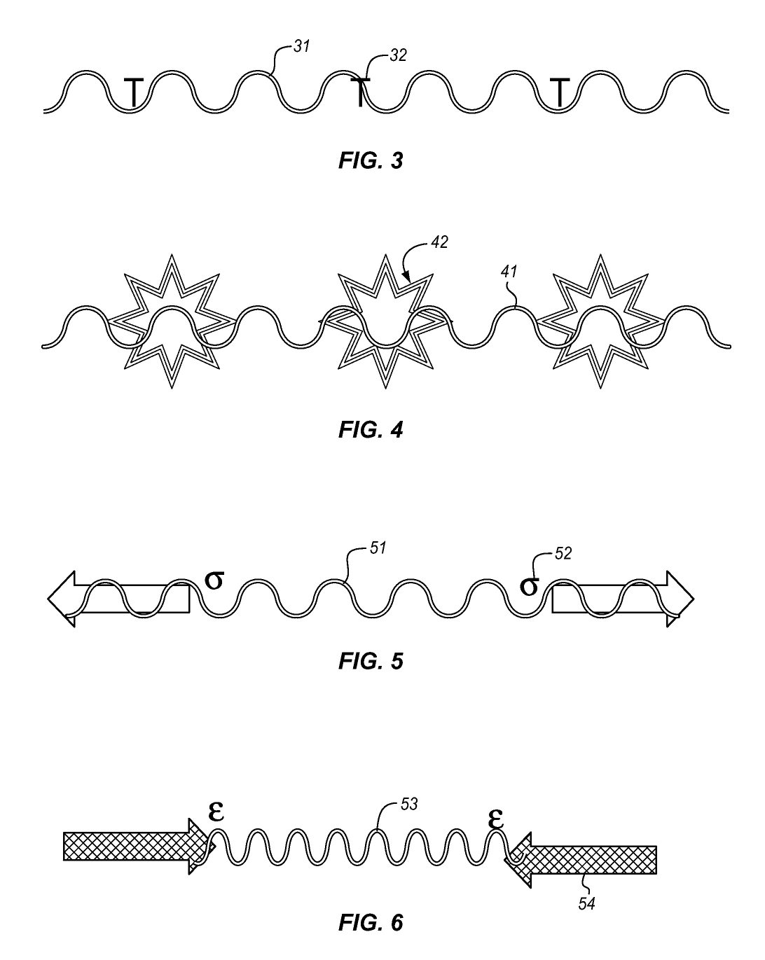

A variety of different functions can be accomplished using sensing and actuating fibers. FIG. 3 shows an example of a sensing electronic thread 31 that measures temperature 32. The measured temperature is the ambient surrounding the thread. Such a thread may be used to sense temperature in particular localized areas of a garment or other fabric devices. Multiple temperature sensors may be used to sense temperature in different locations or a single temperature sensor may sense temperature in one or more locations.

There are many different types of threads that may be used as temperature sensors. Some specific examples of electronic threads are conducting polymers. For a simpler measure of temperature, materials having a stronger temperature-related effect may be used. Interconnection between the threads and to the CPU can occur in these materials if the conductivity of the combined threads within the garment is strong enough. If the sensing threads do not have sufficient conductivity, threads with a higher conductivity may be interwoven with the electronic threads.

A variety of different temperature-related effects may be exhibited in materials that can be formed as or into threads. The thermo-resistive effect is a change in the resistance of a thread with temperature. A thread with a sufficiently high thermo-resistive coefficient can serve as a sensor for temperature as indicated in FIG. 2. The processor measures the resistance in the wire and uses it as a representation of the temperature of the sensor or of the fabric as a whole.

An example thermoresistance material is poly[2-methoxy-5-(2′-ethylhexyloxy)-p-phenylene vinylene] (MEH-PPV)

The pyroelectric effect is the generation of a temporary voltage when a material is heated or cooled. The processor measures the voltage applied by the sensor and uses the voltage as a representation of temperature.

An example pyroelectric material is polyvinylidene fluoride (PVF2). It may have a voltage of about 35 mC/(m²K)

The thermoelectric effect is the direct conversion of temperature differences to electric voltage and vice-versa. The ZT of a thermoelectric material is a dimensionless figure of merit that is used to compare the efficiencies of various materials.

An example thermoelectric material is poly(3,4-ethylenedioxythiophene) (PEDOT) which may have a figure of merit ZT=0.25

FIG. 4 shows an example an electronic thread 41 that may be used to act as a transducer generate heat 42 or to eliminate heat 42 to heat or cool a fabric in response to the application of a voltage. The fabric may be heated by the dissipation of Joule heat in the resistance of the actuating thread. Alternatively, using a different transducer thread, the fabric may be made to absorb heat, or to cool the fabric or an article wrapped in the fabric by the application of the current.

An example Joule heating thread is a dispersion of two materials such as PEDOT (poly(3,4-ethylenedioxythiophene)):(PSS=polystyrene sulfonic acid) A junction of two different types of materials can remove heat if a current is passed through it.

Thermal properties maybe combined in the sensing threads and the transuding threads to achieve a variety of different effects. In a combination, the thermo-resistive, Joule heating, and junction effects can be used to maintain the temperature of clothing worn by a human, or of a fabric applied to an appliance within a certain range.

In a simple example, a fabric device senses a temperature and then responds by either heating or cooling depending on the sensed temperature. This may be useful not only in clothing but also in curtains and drapes and in industrial pipe wraps, among other examples. The temperature sensors may be augmented in the fabric by additional types of sensors that are associated with temperature. For example in a garment a temperature sensor and a moisture sensor may be combined. If a sensed temperature is only somewhat high but a moisture sensor has determined that a person wearing the garment is a little warm but is also sweating profusely, then the garment may be made to start a cooling transducer even without an extremely high temperature.

FIG. 5 shows an example of a sensor thread that measures stress by the change of the electrical resistance of the thread. The thread 51, if attached to or woven into the fabric, is pulled by the moving of the fabric. The thread generates a change in resistance 52 proportional to the movement which can be interpreted by the processor of the SOC as a stress, a stretch or a movement. The piezo-resistive effect for example, may be used to measure stress. The resistance of a piezo-resistive wire changes if the wire is under mechanical stress. The resistance of the wire can be measured by the processor and interpreted as an indication of stress.

An example piezo-resistive material with an effect of 10⁻⁴/Pa is indium-tin-oxide/poly[2-methoxy-5-(2-ethylhexyloxy)-1,4-phyenylenevinylene] (MEH-PPV)/Al.

Alternatively, the stress can be sensed via the piezo-electric effect. The piezo-electric effect creates a charge imbalance in response to physical stress. A piezo-electric effect of 6-7 pC/N can be achieved with polyvinylidene fluoride

The measured stress may be applied as an input by the processor. The input may be applied to an adjustment or conversion algorithm to apply to the activation of a transducer. In FIG. 6, a thread 63 has a voltage applied to it which causes the thread to shrink as shown by arrows 64. Using this system, a fabric may be designed to counter stretches and pulls with a constrictive or repulsive force in the opposite direction. Therefore the size, shape and position of the fabric can be adjusted.

In a reverse piezo-electric effect, deformation can be induced by applying a voltage to a thread. A similar type of thread or the same thread as describe above for the piezo-electric sensor may be used. Alternatively electrostrictive polymers are electroactive polymers that deform due to the electrostatic and polarization interaction between two electrodes with opposite electric charge. An electrostrictive polymer with a coefficient within the range of 10¹⁵ m²/V², such as poly(vinylidene fluoride-trifluoroethylene-chlorofluoroethylene) [P(VDF-TrFE-CFE)] may be used.

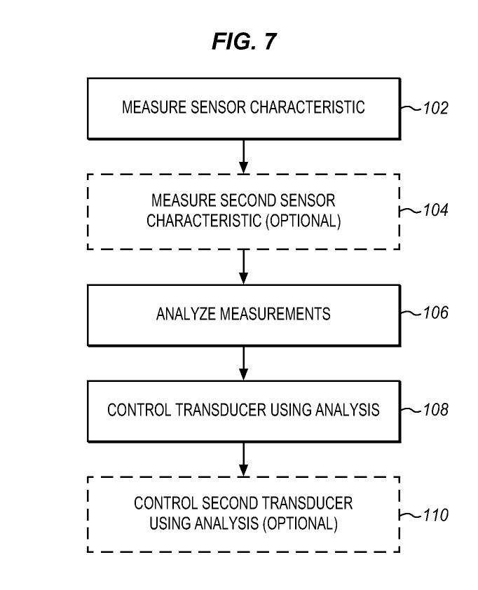

The behavior of a fabric as described herein may be further understood by reference to FIG. 7. FIG. 7 is a process flow diagram for controlling and operating a fabric as shown for example in FIGS. 1 and 2. At 102 the characteristics of a sensor thread are measured. As described above, this may be done by measuring resistance, voltage, or some other characteristic of the sensor threads. At 104 the characteristics of a second sensor thread are optionally measured. These sensors may measure the same physical characteristics such as temperature at two different locations or two different characteristics such as a temperature and a moisture level or temperature and a physical stress or temperature measured in two different ways. So for example, a thermoresistive thread and a pyroelectric thread may be used in the same fabric to make two different kinds of temperature measurements at the same time.

At 106 the measurements are analyzed and at 108 a transducer is controlled based on the analysis at 106. At 110 a second controlled transducer may optionally be controlled based on the analysis. The second transducer may be a transducer for a different location in the fabric or it may be a transducer to cause a different effect.

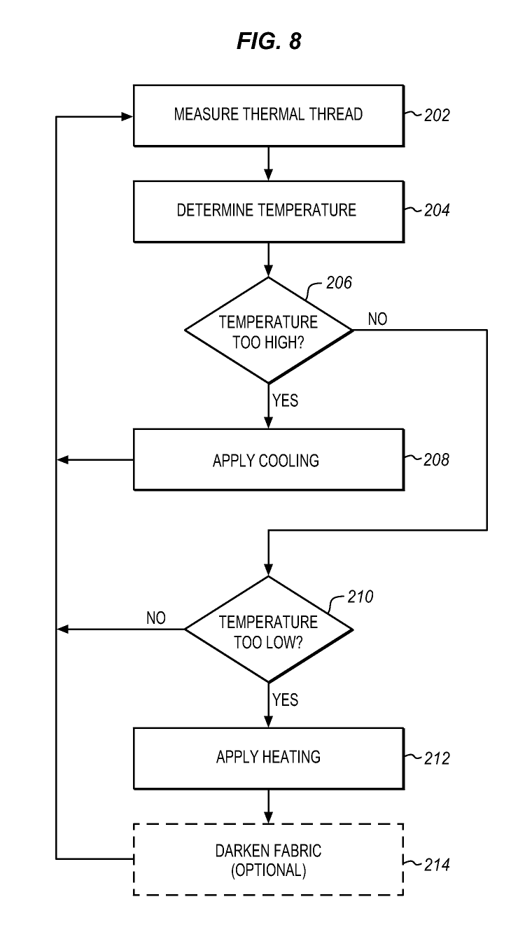

FIG. 8 is a process flow diagram of a specific application of a sensing fabric as shown in FIGS. 1 and 2. At 202 the characteristics of a thermal sensing thread are measured. At 204 the processor analyzes this measurement and determines a relative temperature of the fabric. The measurement may be in actual units or converted to actual units such as temperature degrees or the temperature may be in the form of a resistance or voltage. At 206 the processor determines if the temperature is too high. This may be done by a reference to a threshold or in any of a variety of other ways. If the temperature is too high, then at 208 cooling is applied. At 210, using the same thermal thread, the processor determines if the temperature is too low. If the temperature is too low, then at 212 a heating thread can be actuated for example by applying a current from the battery through a thread that heats the fabric. Optionally at 214 an additional transducer may be used to provide for additional heating. For example the first thread may provide Joule heating and a second thread may darken the fabric so that it absorbs more heat from surrounding light sources. After the transducers have been applied to control the fabric, the process returns at 202 to measure the characteristics of the thermal sensor thread.

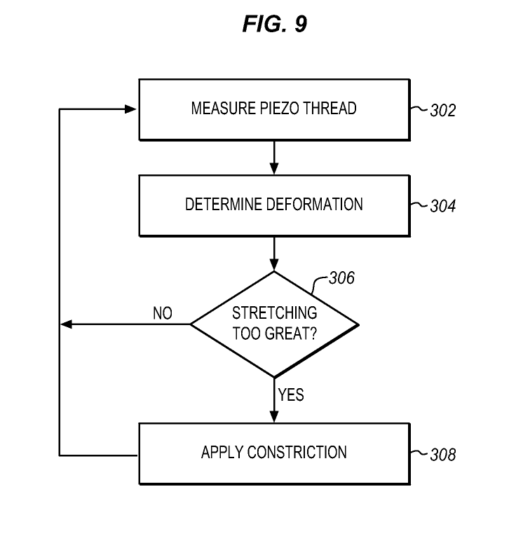

FIG. 9 shows an alternative example of using a fabric as described herein. At 302 the stress on a piezo thread is measured to determine the amount of deformation of the fabric. At 304 the processor analyzes this measurement and determines an amount of deformation. At 306 this amount of deformation is analyzed to determine if it is too high. If the deformation is too high then at 308 a constriction force may be applied to the fabric through a piezo constrictive thread for example. After applying constriction, the deformation of the sensing thread may be measured again to determine if the applied constriction is sufficient.

In addition to the examples provided above, various other types of sensors may be employed instead of or in addition to those described. Photodetector threads respond to intensity of light. Magnetic field can change the resistance of wires. Chemical sensors change their conductance in the presence of specific chemicals on their surface. Many other examples may be used.

Various properties of the fabric other than those mentioned above may also be modified. As an example, the transparency or color of the fabric may be changed. The surface tension coefficient for liquids on the fabric may be changed to modify wetting characteristics. Other changes may also be used. The magnetoelectric (ME) effect is a phenomenon of inducing or switching magnetization by applying an external electric field. The inverse magnetoelectric effect is a change of electric field in response to a change of magnetization, e.g. caused by external magnetic fields. This may be used to modify optical or electrical interactions and properties of the fabric. A coefficient of 3 V/Oe may be obtained by wrapping polymer-based pseudo-1-3 (Tb_{0.3}Dy_{0.7})_{0.75}Pr_{0.25}Fe_{1.55} around particles of 0.7*Pb(Mg_{1/3}Nb_{2/3}) O₃+0.3*PbTiO₃ (PMN-PT).

In addition different responses may be programmed to be connected to various sensed physical quantities. All of the adjustments may be done by the processor without human interference. This provides the fabric with seemingly sentient qualities.

In addition to the applications described above, the fabric and control system may be used for sensing and adjusting the environment for the human body, especially in dangerous situations. Such a fabric may provide protection from temperature, electric fields, magnetic fields, or mechanical stress, among others. Such a fabric may make clothing more comfortable by change size to fit the body.

In addition to garments, a sentient fabric may be used in camping and military equipment, such as sleeping bags. The same sleeping bag may be made responsive to the temperature, light, moisture, and other factors, so that it may be useful in the desert, in a rainforest and in the arctic. Similarly, the fabric may be used as a hypothermia wrap and as a hyperthermia wrap in rescue circumstances.

A sentient fabric may also be used as draping or furniture upholstery to adapt to conditions outside or inside a building. As an example, the piezo threads may be used to cause drapes to move to cover or uncover a window in response to temperature. The drapes may also be made to become more or less opaque or more or less dark in response to temperature or the sunlight measured by the drapes. Such a fabric may be used to adjust packaging to fit the shape of a packaged object. Such a fabric may be used for wrapping in manufacturing, for example, protection screens for gases or protection screens for small particles around moving machinery.

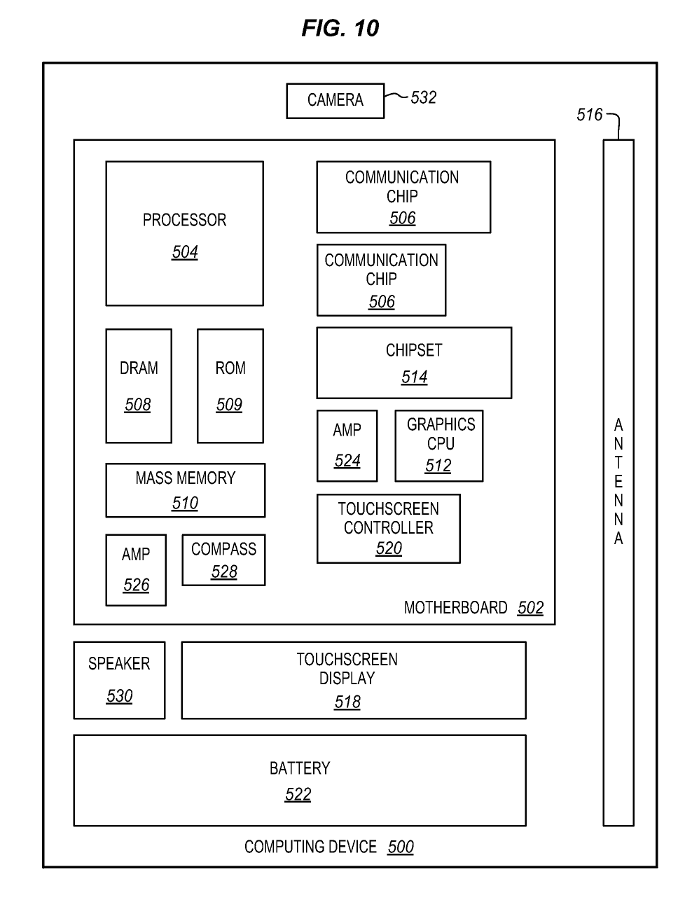

FIG. 10 illustrates a computing device 500 in accordance with one implementation of the invention. Such a computing device may be used as the internal processor or SOC 12 described above for controlling the fabric. The computing device 500 houses a board 502. The board 502 may include a number of components, including but not limited to a processor 504 and at least one communication chip 506. The processor 504 is physically and electrically coupled to the board 502. In some implementations the at least one communication chip 506 is also physically and electrically coupled to the board 502. In further implementations, the communication chip 506 is part of the processor 504.

Depending on its applications, computing device 500 may include other components that may or may not be physically and electrically coupled to the board 502. These other components include, but are not limited to, volatile memory (e.g., DRAM) 508, non-volatile memory (e.g., ROM) 509, flash memory (not shown), a graphics processor 512, a digital signal processor (not shown), a crypto processor (not shown), a chipset 514, an antenna 516, a display 518 such as a touchscreen display, a touchscreen controller 520, a battery 522, an audio codec (not shown), a video codec (not shown), a power amplifier 524, a global positioning system (GPS) device 526, a compass 528, an accelerometer (not shown), a gyroscope (not shown), a speaker 530, a camera 532, and a mass storage device (not shown), and so forth. These components may be connected to the system board 502, mounted to the system board, or combined with any of the other components.

The communication chip 506 enables wireless and/or wired communications for the transfer of data to and from the computing device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 506 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 500 may include a plurality of communication chips 506. For instance, a first communication chip 506 may be dedicated to shorter range wireless communications such as Wi-Fi and Bluetooth and a second communication chip 506 may be dedicated to longer range wireless communications such as GPS, EDGE, GPRS, CDMA, WiMAX, LTE, Ev-DO, and others.

The processor 504 of the computing device 500 includes an integrated circuit die packaged within the processor 504. The term “processor” may refer to any device or portion of a device that processes electronic data from registers and/or memory to transform that electronic data into other electronic data that may be stored in registers and/or memory.

Embodiments may be implemented as a part of one or more memory chips, controllers, CPUs (Central Processing Unit), microchips or integrated circuits interconnected using a motherboard, an application specific integrated circuit (ASIC), and/or a field programmable gate array (FPGA).

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The following examples pertain to further embodiments. The various features of the different embodiments may be variously combined with some features included and others excluded to suit a variety of different applications. Some embodiments pertain to a fabric that comprises a sensor, the sensor being formed of a thread having a characteristic that changes in response to an environmental condition, a transducer formed of a thread having a physical response to an applied power, and a processor coupled to the sensor to measure the sensor characteristic and to the transducer to apply the power to the transducer based on the sensor measurement. In further embodiments, the fabric also includes power supply to power the processor and to provide the power applied to the transducer. In further embodiments, the power supply may be photovoltaic, formed of photovoltaic threads, or formed of an antenna for wireless power delivery.

In further embodiments, the fabric may include woven threads and either the sensor, the transducer or both are formed of at least one thread woven into the fabric. In further embodiments, the fabric comprises a second sensor of the fabric having a second characteristic that changes in response to a second environmental condition. The processor is coupled to the second sensor to measure the second characteristic and to apply the power to the transducer based on a combination of the first and second sensor measurements. The combination of the first and second sensor measurements may comprise a combination of temperature and light.

In further embodiments, the sensor measures one or more of temperature by a change of resistance, stress applied to the fabric, and light intensity. The transducer has a physical response of one or more of producing heat in response to the applied power, dissipating heat in response to the applied power, contracting in response to the applied power, expanding in response to an applied power, changing opacity of the fabric and changing color of the fabric.

In further embodiments, the fabric comprises a second transducer being formed of a thread woven into the fabric having a second physical response to an applied power. The processor applies power to one of the first transducer, the second transducer, and no transducer based on the sensor measurement.

In further embodiments, the transducer also has a second physical response of expanding in response to a second applied power. The processor applies power to the transducer to cause the first response or the second response based on the sensor measurement.

In another embodiment, a method comprises measuring a characteristic of a thread of a fabric, comparing the measured characteristic to a threshold, and conditionally activating a transducer that is another thread of the fabric based on the comparison. In further embodiments, the method includes measuring a characteristic of a second thread of the fabric, and comparing the characteristic of the second thread to a second threshold and conditionally activating comprises conditionally activating the transducer based on the first and the second comparison.

In another embodiment a method of making a fabric having a sensor and a transducer comprises weaving a sensor thread into structural threads of a fabric, weaving a transducer thread into structural threads of the fabric, attaching a processor to the fabric, and connecting the sensor and transducer threads to the processor. Further embodiments include attaching an antenna for wireless power supply to the fabric and connecting the antenna to the processor and weaving galvanic threads into the fabric to form a power supply and connecting the galvanic threads to the processor to power the processor.

In another embodiment, a system comprises a sensor fiber having a characteristic that changes in response to an environmental condition, a transducer fiber having a physical response to an applied power, and a processor coupled to the sensor fiber to measure the sensor characteristic and to the transducer fiber to apply the power to the transducer fiber based on the measured sensor characteristic. Further embodiments include structural fibers to carry the sensor fiber and the structural fiber. Further embodiments include a second transducer fiber having a second physical response to an applied fiber and wherein the processor applies the power to one of the first and the second transducer fiber based on the measured sensor characteristic.

What is claimed is:

1. A fabric comprising:
a sensor, the sensor being formed of a thread having a characteristic that changes in response to an environmental condition;
a transducer formed of a thread having a physical response to an applied power; and
a processor coupled to the sensor to measure the sensor characteristic and to the transducer to apply the power to the transducer based on the sensor measurement.

2. The fabric of claim 1, further comprising a power supply to power the processor and to provide the power applied to the transducer.

3. The garment of claim 2, wherein the power supply is photovoltaic.

4. The fabric of claim 3, wherein the power supply is formed of photovoltaic threads.

5. The fabric of claim 1, further comprising an antenna for wireless power delivery.

6. The fabric of claim 1, comprising woven threads and wherein at least one of the sensor and the transducer are formed of at least one thread woven into the fabric.

7. The fabric of claim 1, further comprising a second sensor of the fabric having a second characteristic that changes in response to a second environmental condition, and wherein the processor is coupled to the second sensor to measure the second characteristic and to apply the power to the transducer based on a combination of the first and second sensor measurements.

8. The fabric of claim 1, wherein the sensor measures at least one of temperature by a change of resistance, stress applied to the fabric, and light intensity.

9. The fabric of claim 1, wherein the transducer has a physical response of at least one of producing heat in response to the applied power, dissipating heat in response to the applied power, contracting in response to the applied power, expanding in response to an applied power, changing opacity of the fabric and changing color of the fabric.

10. The fabric of claim 9, further comprising a second transducer being formed of a thread woven into the fabric having a second physical response to an applied power, and wherein the processor applies power to one of the first transducer, the second transducer, and no transducer based on the sensor measurement.

11. The fabric of claim 9, wherein the transducer also has a second physical response of expanding in response to a second applied power and wherein the processor applies power to the transducer to cause the first response or the second response based on the sensor measurement.

12. A method comprising:
measuring a characteristic of a thread of a fabric;
comparing the measured characteristic to a threshold;
conditionally activating a transducer that is another thread of the fabric based on the comparison.

13. The method of claim 12, further comprising measuring a characteristic of a second thread of the fabric, and comparing the characteristic of the second thread to a second threshold and wherein conditionally activating comprises conditionally activating the transducer based on the first and the second comparison.

14. The method of claim 12, wherein measuring the characteristic comprises measuring the temperature, the method further comprising determining an amount of light by measuring a characteristic of a second thread, and wherein conditionally activating comprises conditionally activating a heating thread based on a combination of the temperature and light.

15. A method of making a fabric having a sensor and a transducer comprising:
weaving a sensor thread into structural threads of a fabric;
weaving a transducer thread into structural threads of the fabric;
attaching a processor to the fabric; and
connecting the sensor and transducer threads to the processor.

16. The method of claim 15, further comprising attaching an antenna for wireless power supply to the fabric and connecting the antenna to the processor.

17. The method of claim 15, further comprising weaving galvanic threads into the fabric to form a power supply and connecting the galvanic threads to the processor to power the processor.

18. A system comprising:
a sensor fiber having a characteristic that changes in response to an environmental condition;
a transducer fiber having a physical response to an applied power; and
a processor coupled to the sensor fiber to measure the sensor characteristic and to the transducer fiber to apply the power to the transducer fiber based on the measured sensor characteristic.

19. The system of claim 18, further comprising structural fibers to carry the sensor fiber and the structural fiber.

20. The system of claim 19, further comprising a second transducer fiber having a second physical response to an applied fiber and wherein the processor applies the power to one of the first and the second transducer fiber based on the measured sensor characteristic.
